(19) United States
(12) Patent Application Publication
(10) Pub. No.: US 2022/0080526 A1
(43) Pub. Date: Mar. 17, 2022

(54) LASER PROCESSING APPARATUS, LASER PROCESSING METHOD, AND METHOD FOR PROCESSING A WORKPIECE

(71) Applicant: NICHIA CORPORATION, Anan-shi (JP)

(72) Inventor: Shinji KAMEDA, Yokohama-shi (JP)

(73) Assignee: NICHIA CORPORATION, Anan-shi (JP)

(21) Appl. No.: 17/474,717

(22) Filed: Sep. 14, 2021

(30) Foreign Application Priority Data
Sep. 15, 2020 (JP) 2020-154810

(51) Int. Cl. B23K 26/082; B23K 26/06; B23K 26/073; B23K 26/21; B23K 26/38

(52) U.S. Cl. CPC B23K 26/082; B23K 26/0648; B23K 26/0643; B23K 26/21; B23K 26/38; B23K 26/0736

(57) ABSTRACT

A laser processing apparatus includes: a light source device configured to emit a laser beam; a laser head having a lens and being configured to converge through the lens a laser beam emitted from the light source device and to irradiate a target object with the converged laser beam; a wobbling mechanism configured to wobble a laser beam spot formed on the target object, the laser beam spot having an elliptical shape with a major axis and a minor axis; and a control device configured to control the wobbling mechanism under a wobble mode in which a first wobble frequency along the major axis direction of the laser beam spot is higher than a second wobble frequency along the minor axis direction of the laser beam spot.

### CROSS-REFERENCE TO RELATED APPLICATION

This application claims priority to Japanese Patent Application No. 2020-154810, filed on Sep. 15, 2020, the disclosure of which is hereby incorporated by reference in its entirety.

### BACKGROUND

The present disclosure relates to a laser processing apparatus, a laser processing method, and a method for processing a workpiece.

In recent years, as semiconductor laser diodes (hereinafter abbreviated as “LD”) increase in their output power, techniques have been developed in which semiconductor laser diodes are used as light sources for laser beams, such that a workpiece of material is processed by being directly irradiated with LD light. Such techniques are referred to as direct diode laser (DDL) techniques.

Japanese National Phase PCT Laid-Open Publication No. 2018-520007 (“Patent Document 1”) discloses a fiber laser apparatus in which a workpiece can be welded by scanning a laser beam thereon, where a laser beam spot that is formed on the workpiece is wobbled.

### SUMMARY

It is desired to reduce differences in processing line width that are associated with the scanning direction of a laser beam in laser-processing a target object.

In a non-limiting, illustrative embodiment, a laser processing apparatus according to the present disclosure includes a light source device configured to emit a laser beam; a laser head having a lens and being configured to converge through the lens a laser beam emitted from the light source device and to irradiate a target object with the converged laser beam; a wobbling mechanism configured to wobble a laser beam spot formed on the target object, the laser beam spot having an elliptical shape with a major axis and a minor axis; and a control device configured to control the wobbling mechanism under a wobble mode in which a first wobble frequency along the major axis direction of the laser beam spot is higher than a second wobble frequency along the minor axis direction of the laser beam spot.

In a non-limiting, illustrative embodiment, a laser processing method according to the present disclosure includes converging a laser beam emitted from a light source device and forming on a target object a laser beam spot having an elliptical shape with a major axis and a minor axis; and scanning the target object with the laser beam while wobbling the laser beam spot under a wobble mode in which a first wobble frequency along the major axis direction of the laser beam spot is higher than a second wobble frequency along the minor axis direction of the laser beam spot.

In a non-limiting, illustrative embodiment of the present disclosure, a method for processing a workpiece includes a step of welding the workpiece by using the aforementioned laser processing method.

In a non-limiting, illustrative embodiment, another method for processing a workpiece according to the present disclosure includes a step of performing a punching process on a surface of the workpiece by using the aforementioned laser processing method.

According to certain embodiments of the present disclosure, there is provided a laser processing apparatus, a laser processing method, and a method for processing a workpiece involving the laser processing method, each of which allows for reducing differences in processing line width that are associated with the scanning direction of a laser beam in laser-processing a target object.

### BRIEF DESCRIPTION OF THE DRAWINGS

FIG. 1 is a block diagram schematically showing an example configuration of a laser processing apparatus according to an illustrative embodiment of the present disclosure.

FIG. 2 is a schematic diagram showing a typical example configuration of a galvano scanner according to an illustrative embodiment of the present disclosure.

FIG. 3 is a block diagram showing an example hardware configuration for a control device according to an illustrative embodiment of the present disclosure.

FIG. 4A is a diagram showing a state where the scanning direction of a laser beam is parallel to the minor axis direction of an elliptical spot.

FIG. 4B is a diagram showing a state where the scanning direction of a laser beam intersects the minor axis direction of an elliptical spot at 90°.

FIG. 4C is a diagram showing a state where the scanning direction of a laser beam intersects the minor axis direction of an elliptical spot at 45°.

FIG. 5A is a graph showing an example wobble pattern of a laser beam spot.

FIG. 5B is a graph showing an example wobble pattern of a laser beam spot.

FIG. 5C is a graph showing an example wobble pattern of a laser beam spot.

FIG. 6A is a graph illustrating example curves according to Comparative Example, obtained by plotting integrated light amount values along the X₁ axis direction and along the Y₁ axis direction.

FIG. 6B is a graph illustrating example curves obtained by plotting integrated light amount values along the X₁ axis direction and along the Y₁ axis direction, in the case where the beam spot is wobbled according to the example wobble pattern of FIG. 5.

FIG. 7 is a graph showing an example wobble pattern of a circular laser beam spot.

FIG. 8 is a diagram showing an example configuration for the light source device, which emits a combined laser beam that is obtained through wavelength beam combining.

### DETAILED DESCRIPTION

Hereinafter, with reference to the drawings, embodiments of the present disclosure will be described in detail. The following embodiments are only exemplary, and the laser processing apparatus, laser processing method, and method for processing a workpiece according to the present disclosure are not limited to the following embodiments. For example, numerical values, shapes, materials, steps, and orders of steps, etc., that are indicated in the following embodiments are only exemplary, and admit of various modifications so long as it makes technological sense. The various implementations described below are only exemplary, and can be combined in a variety of manners so long as it makes technological sense to do so.

Note that the dimensions, shapes, etc. of any component elements shown in a drawing may be exaggerated for ease of understanding, and thus may not strictly reflect their dimensions, shapes, and relative sizes between component elements in an actual laser processing apparatus. In order to avoid excessive complexity of the drawings, certain elements may be omitted from illustration.

In the following description, component elements having substantially identical functions may be denoted by identical reference numerals, with their description being omitted. Terms indicating specific directions or positions (e.g., “upper”, “above”, “over”, “lower”, “below”, “under”, “right”, and “left”, or any other terms of which these are parts) may be used. These terms are merely being used to indicate relative directions or positions in the drawing under attention, in a manner that provides easy understanding. So long as the relative directions or positions as indicated by terms such as “above”, “below”, etc., in the drawing under attention are conserved, any drawing employed outside the present disclosure, actually manufactured products, production apparatuses, or the like may not adhere to the same exact positioning as that indicated in the drawing under attention.

FIG. 1 is a block diagram schematically showing an example configuration for a laser processing apparatus 1000 according to an embodiment of the present disclosure. The laser processing apparatus 1000 includes: a light source device 100; a laser head 300 including a wobbling mechanism 200 and a lens 240; a digital-to-analog converter (D/A converter) 400; and a control device 500. In the present embodiment, the D/A converter 400 and the control device 500 will be described as component elements of the laser processing apparatus 1000. However, these may alternatively be external component elements that are connected to the laser processing apparatus 1000; in that case, the control device 500 is to be connected externally to the main body of the laser processing apparatus 1000 via the D/A converter 400. This connection may be in wired or wireless form.

The laser processing apparatus 1000 may further include an imaging device such as a camera. For example, a camera can be used to monitor the state of a bonding surface before welding, the melting state during the welding, and/or the state of a weld bead after welding. The imaging data that is obtained with the camera may be utilized as a trigger for starting or stopping the driving of the laser processing apparatus 1000, for example.

The laser processing apparatus 1000 operates in accordance with instructions which are output from the control device 500. The laser processing apparatus 1000 forms a laser beam spot having an elliptical shape on a target object, and scans the target object with the laser beam, while wobbling the laser beam spot. Hereinafter, a laser beam spot may simply be referred to as a “beam spot”. The laser processing apparatus 1000 can be used as an apparatus for performing processes such as cutting, punching, marking, etc., or welding a metal material, for example.

The light source device 100 includes an LD(s) to emit laser light L toward the wobbling mechanism 200. The number of LDs is not particularly limited, and may be determined in accordance with the optical output power or irradiance that is needed. The LD(s) may be a semiconductor laser diode(s) made of a nitride semiconductor-based material, and may output near-ultraviolet, violet, blue, or green laser light, for example. The wavelength of the laser light may be selected in accordance with the material to be processed. For example, when processing copper, brass, aluminum or the like, an LD(s) whose central wavelength is in the range of 350 nm to 550 nm may suitably be adopted. In the case of using a plurality of LDs, the wavelength of laser light that is radiated from each LD does not need to be the same, and laser light of different central wavelengths may be superposed; this aspect will be described in detail later. Each LD may be embodied as a semiconductor laser package. The inside of the semiconductor laser package is filled with an inert gas, e.g., a nitrogen gas of high cleanliness or a noble gas, and the semiconductor laser package may be hermetically sealed. Hermetic sealing can reduce influences of collection of dust by laser light. However, hermetic sealing is not essential.

The wobbling mechanism 200 includes a driver 210, a motor 220, and a mirror 230. The wobbling mechanism 200 is configured so as to wobble an elliptical beam spot S that is formed on a target object W. An example of the wobbling mechanism 200 is a galvano scanner. In the present embodiment, a galvano scanner is adopted as the wobbling mechanism 200. By utilizing a galvano scanner, highly precise control of the position of the beam spot can be achieved.

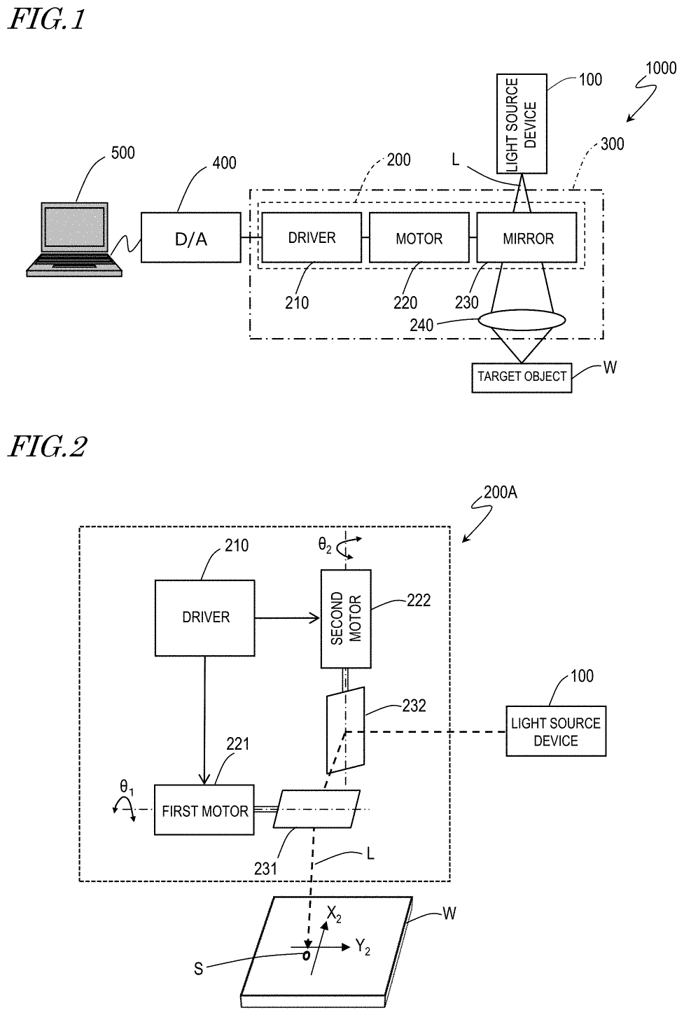

FIG. 2 is a schematic diagram showing an example configuration for a galvano scanner 200A. The galvano scanner 200A in the present embodiment is able to perform biaxial scanning along X₂ and Y₂ axes. The X₂Y₂ coordinate system, which is used for describing the control of the beam spot position, is a local coordinate system on the target object W, or on a stage on which the target object W is placed. The orientation of this coordinate system may or may not be identical to the orientation of the local coordinate system of the aforementioned elliptical spot. In FIG. 2, for simplicity, a light beam on the optical axis of the laser light L is illustrated with broken lines. For simplicity, FIG. 2 does not show the lens 240, which is placed on the optical path between the first scan mirror 231 and the beam spot S.

The galvano scanner 200A includes the driver 210, a first motor 221, a second motor 222, a first scan mirror 231, and a second scan mirror 232. The first motor 221 and the second motor 222 may each be referred to as a galvano motor. The first scan mirror 231 and the second scan mirror 232 may each be referred to as a galvano mirror.

The first scan mirror 231 is attached to a shaft of the first motor 221, and is supported so as to be capable of rotating around a rotation axis θ₁. The second scan mirror 232 is attached to a shaft of the second motor 222, and is supported so as to be capable of rotating around a rotation axis θ₂. As the first scan mirror 231 is rotated around the rotation axis θ₁, the beam spot S can be moved along the X₂ axis direction. As the second scan mirror 232 is rotated around the rotation axis θ₂, the beam spot S can be moved along the Y₂ axis direction. In the present embodiment, the beam spot S is able to move in the range of e.g. 0 mm to 100 mm along the X₂ axis direction, and move in the range of e.g. 0 mm to 100 mm along the Y₂ axis direction. In the X₂Y₂ plane of the X₂Y₂ coordinate system, a region to be processed that measures e.g. 80 mm×80 mm can be scanned by the galvano scanner 200A with a laser beam. However, the extent of the region to be processed depends on the focal length of an fθ lens to be described later.

The driver 210 is connected to the first motor 221 and the second motor 222. The galvano scanner 200A includes position sensors for detecting angles of rotation that are indicative of the respective mirror positions of the first scan mirror 231 and the second scan mirror 232. Examples of position sensors include rotary encoders and magnetic sensors. The driver 210 receives command position values that are output from the control device 500. The driver 210 drives the first motor 221 so that the position of the first scan mirror 231 as indicated by a sensor output from the position sensor accurately follows the command position values. Similarly, the driver 210 drives the second motor 222 so that the position of the second scan mirror 232 as indicated by a sensor output from the position sensor accurately follows the command position values. For example, transmission of command values from the control device 500 to the driver 210 may be performed through voltage control. The driver 210 supplies command voltages to the first motor 221 and the second motor 222 to drive the respective motors. As a result, the first motor 221 makes a rotation around the rotation axis θ₁ by an angle that is proportional to the command voltage, and the second motor 222 makes a rotation around the rotation axis θ₂ by an angle that is proportional to the command voltage.

In the example of FIG. 2, the laser light L which is emitted from the light source device 100 changes its propagation direction as it is reflected by each of the first scan mirror 231 and the second scan mirror 232. The second scan mirror 232 reflects the laser light L being emitted from the light source device 100 so that it is directed toward the first scan mirror 231. The first scan mirror 231 reflects the laser light L being reflected by the second scan mirror 232 so that it is directed toward the target object W. However, the configuration of the optical system is not limited to this example. For instance, in the case where the laser light L is incident on the wobbling mechanism 200 in a direction that is parallel to the direction that the rotation axis θ₂ of the second scan mirror 232 extends, a further mirror may be added in order to direct the reflected light toward the second scan mirror 232, thereby changing the propagation direction of the laser light L.

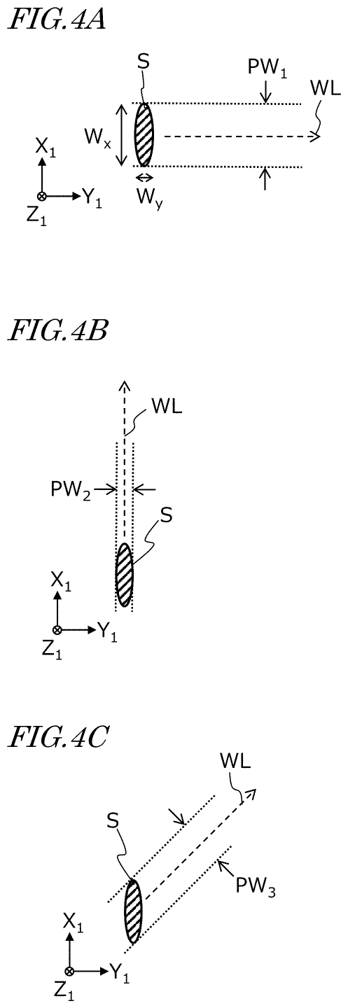

In addition to wobbling the beam spot S with a predetermined pattern, the wobbling mechanism 200 serves to move the beam spot S with a predetermined velocity along a scanning direction WL shown in FIGS. 4A, 4B and 4C, for example, thus causing a scan movement of the laser beam. The scanning rate of the laser beam may be about 2 mm/sec, for example.

Without being limited to a galvano scanner, the wobbling mechanism 200 may be a combination of a galvano scanner and a polygon scanner, for example. The galvano scanner 200A may perform not only biaxial scanning, but also multiaxial scanning along e.g. three axes. For example, by performing triaxial scanning, even a target object W having a three-dimensional shape can be precisely marked. Instead of or in addition to a galvano scanner, a movable stage that is capable of moving in the X₂Y₂ plane may be adopted as a wobbling mechanism for controlling the position of the beam spot S.

FIG. 1 is referred to again.

The laser head 300 includes the wobbling mechanism 200 and the lens 240. The laser head 300 converges the laser light L emitted from the light source device 100 through the lens 240, and irradiates the target object W with the converged laser beam. The lens 240 is a converging lens, which is preferably an fθ lens. The θ lens may be a telecentric type or a non-telecentric type. By using an fθ lens, a flat image plane can be created on the target object W. In the present embodiment, the focal length of the fθ lens is about e.g. 300 mm. Using an fθ lens with a long focal length enlarges the scanning range of the laser beam. Conversely, using an fθ lens with a short focal length allows the processing line width to become thin, thus enabling more precise processing.

The D/A converter 400 in the present embodiment has a 16-bit resolution, for example. Based on a command value which is in the form of a digital signal being output from the control device 500, the D/A converter 400 generates a command voltage value in the form of an analog signal, which is then output to the driver 210.

A typical example of the control device 500 is a personal computer. The control device 500 is connected to the driver 210 of the wobbling mechanism 200 via the D/A converter 400.

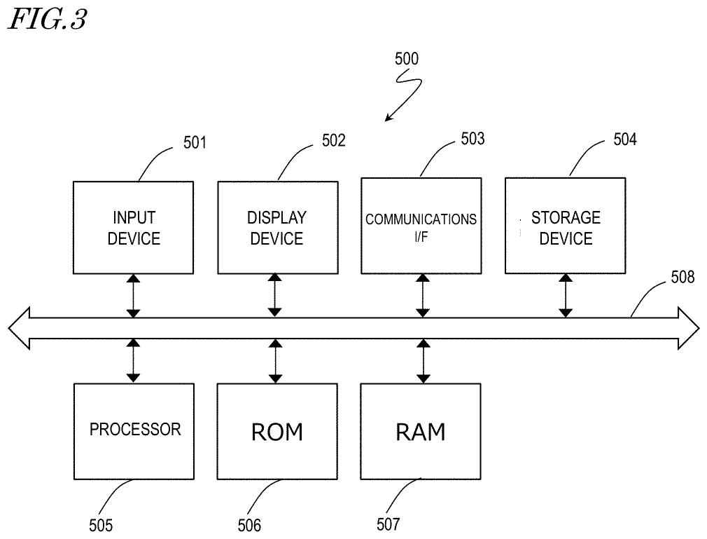

FIG. 3 is a block diagram showing an example hardware configuration for the control device 500. The control device 500 includes an input device 501, a display device 502, a communications I/F 503, a storage device 504, a processor 505, a ROM (Read Only Memory) 506, and a RAM (Random Access Memory) 507. These component elements are connected so as to be capable of communication with one another via a bus 508.

The input device 501 is a device for converting instructions from a user into data for input to a computer. The input device 501 may be a keyboard, a mouse, or a touchscreen panel, for example.

The display device 502 may be a liquid crystal display or an organic EL display, for example. The display device 502 displays an input box in which to input various conditions for controlling the wobbling mechanism 200, etc., for example.

The communications I/F 503 is an interface for mainly transmitting data of command values from the control device 500 to the D/A converter 400. So long as command values can be transferred, any protocol may be used without limitation. For example, the communications I/F 503 is able to perform wired communication based on USB, IEEE1394 (registered trademark), or Ethernet (registered trademark), or other standards. The communications I/F 503 may be able to perform wireless communication under the Bluetooth (registered trademark) standards and/or Wi-Fi (registered trademark) standards. These standards all include wireless communication standards utilizing frequencies in the 2.4 GHz band or the 5.0 GHz band.

The storage device 504 may be a solid-state drive (SSD), a magnetic storage device, an optical storage device, or any combination thereof, for example. An example of an optical storage device is an optical disc drive. Examples of magnetic storage devices are a hard disk drive (HDD), a floppy disk (FD) drive, and a magnetic tape recorder.

The processor 505 is a semiconductor integrated circuit, also referred to as a central processing unit (CPU) or a microprocessor. The processor 505 consecutively executes a computer program in which instructions for controlling the wobbling mechanism 200 are stated, this being stored in a ROM 506, and realizes a desired process. The processor 505 is to be broadly regarded as being inclusive of an FPGA (Field Programmable Gate Array), an ASIC (Application Specific Integrated Circuit), and an ASSP (Application Specific Standard Product), in which a CPU is mounted.

The ROM 506 may be a writable memory (e.g., a PROM), a rewritable memory (e.g., a flash memory), or a read-only memory, for example. The ROM 506 stores a program for controlling the operation of the processor. The ROM 506 does not need to be a single storage medium, but may be an aggregation of multiple storage media. A part of such an aggregate storage may be a removable memory.

The RAM 507 provides a work area for a control program stored in the ROM 506 to be laid out once at boot time. The RAM 507 does not need to be a single storage medium, but may be an aggregation of multiple storage media.

Hereinafter, wobble patterns for the elliptical beam spot S will be described in detail.

The laser beam which is emitted from an emitter region of an LD is divergent light that has some spread. At a cross section orthogonal to the propagation direction of the laser beam, the laser beam emitted from the LD creates a far field pattern of an elliptical shape. The far field pattern is defined by an optical intensity distribution of the laser beam at a position away from an emission end face of the LD. In the elliptical shape of the far field pattern, the minor axis direction of the ellipse is referred to as the slow-axis direction, and the major axis direction is referred to as the fast-axis direction.

FIGS. 4A, 4B and 4C are diagrams for describing, when a target object is scanned along a predetermined direction with a laser beam that is emitted from an LD and converged by a converging lens, how processing line width may vary depending on the scanning direction. Each of FIGS. 4A, 4B and 4C illustrates an elliptical shape of a beam spot S, on an image plane, of a laser beam that is emitted from an LD and converged by a converging lens, with a broken line showing the scanning direction WL of the laser beam. In the case of welding, for example, the scanning direction WL is a direction that follows along the welding line. Boundaries of the processing line are indicated by dotted lines. For the sake of explanation, an X₁Y₁Z₁ local coordinate system on the image plane is introduced for the beam cross section. In the X₁Y₁Z₁ coordinate system, the minor axis direction and the major axis direction of the laser beam spot are parallel to the Y₁ axis direction and the X₁ axis direction, respectively. The propagation direction of the laser beam is parallel to the Z₁ axis direction.

As illustrated in these figures, since the divergence angle and beam radius of the beam differs between the X₁ axis direction and the Y₁ axis direction, the beam spot S formed on the image plane presents a cross-sectional shape that is an ellipse having a major axis and a minor axis. The major axis of the ellipse is parallel to the X₁ axis direction (i.e., the slow-axis direction), and the minor axis is parallel to the Y₁ axis direction (i.e. the fast-axis direction).

First, consider a case where the beam spot S has a circular shape; in this case, the processing line width does not vary, and is non-dependent on the scanning direction WL. On the other hand, in the case where the beam spot S has an elliptical shape, the processing line width varies depending on the scanning direction WL. In the example of FIG. 4A, the scanning direction WL is parallel to the Y₁ axis direction, i.e., the minor axis direction. In that case, the processing line width PW₁ corresponds to the spot diameter Wₓ of the ellipse along its major axis. In the example of FIG. 4B, the scanning direction WL is parallel to the X₁ axis direction, i.e., the major axis direction. In that case, the processing line widths PW₂ corresponds to the spot diameter W_{y} of the ellipse along its minor axis. In the example of FIG. 4C, the scanning direction WL and is an oblique direction intersecting the X₁ axis direction at 45° . In that case, the processing line width PW₃ is equal to neither the processing line width PW₁ nor PW₂. As a result of this, in the case where the weld zone (or the bonding surface) has a circular region, for example, processing may become difficult for a certain scanning direction(s) due to constraints concerning the processing line width.

In the present embodiment, the control device 500 controls the wobbling mechanism 200 under a wobble mode in which a first wobble frequency f₁ along the major axis direction of the elliptical beam spot S is higher than a second wobble frequency f₂ along its minor axis direction.

In other words, the frequency along the slow-axis direction of the beam spot S is higher than the frequency along its fast-axis direction. The ratio R (=f₁/f₂) of the first wobble frequency f₁ to the second wobble frequency f₂ can essentially be determined based on the ellipticity of the elliptical beam spot S. For example, the elliptical beam spot S has an ellipticity of 5 in the case where its length along the major axis is 200 μm and its length along the minor axis is 40 μm; therefore, the ratio R can be set to 5 in this case.

The ratio R may be adjusted in accordance with the scanning direction of the laser beam. For example, given an ellipticity of 5, rather than setting the ratio R at 5, an optimum value of the ratio may be determined by taking into consideration the scanning direction of the laser beam. For example, differences in processing line width that are associated with the scanning direction can be minimized by choosing a value that is determined based on the relationship between the scanning rate and the wobble frequency.

In the present embodiment, the ratio R may be chosen in a range of 2.0 to 100, for example. As will be described later, from the perspective of making the integrated light amount value uniform without depending on the scanning direction, the ratio R is preferably chosen in a range of 4.0 to 100, for example. Moreover, if the velocity of wobble movement of the beam spot S is too small relative to the rate of beam scanning, the beam scanning may take a meandering course. Therefore, it is preferable to set the wobble frequency so that the beam spot S is moved with a velocity which is sufficiently higher than the rate of beam scanning, so as not to result in a meandering beam scan (i.e., so as to create an irradiated region that is effectively a circular spot with the wobbling elliptical beam spot S). In the present embodiment, when the rate of beam scanning is e.g. about 2 mm/sec, the first wobble frequency f₁ may be set to a value on the order of tens of Hz, and the second wobble frequency f₂ may be set to below that value.

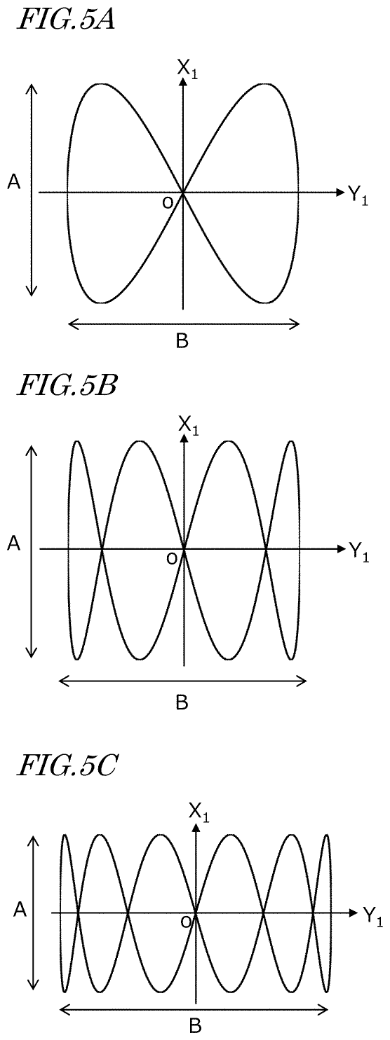

FIGS. 5A 5B and 5C are graphs each showing an example wobble pattern of the beam spot S. Each of these figures illustrates the locus of the center of the ellipse of the beam spot S. In the present embodiment, the spot diameter Wₓ along the X₁ axis direction is 200 μm to 300 μm, and the spot diameter W_{y} along the Y₁ axis direction is 40 μm to 50 μm. The amplitude A along the X₁ axis direction may be not less than 600 μm and not more than 1000 μm, for example. The amplitude B along the Y₁ axis direction may be not less than 600 μm and not more than 1000 μm, similarly to the amplitude A, for example.

In the present embodiment, the wobbling locus of the beam spot S is defined by the formulae Y₁=sin(2πf₁t), X₁=sin(2πf₂t). Herein, 2πf is angular frequency, and t is time (seconds). In the example of FIG. 5A, the ratio R is 2, i.e., f₁=2f₂. The elliptical beam spot S forms on the target object W so that its major axis is parallel to the X₁ axis (i.e., slow axis) direction and that its minor axis is parallel to the Y₁ axis (i.e., fast axis) direction.

In the example of FIG. 5B, the ratio R is 4, i.e., f₁=4f₂. By setting the ratio R to 2 or greater, it becomes possible to introduce a greater number of laser beam scans along the major axis direction than along the minor axis direction.

In the example of FIG. 5C, the ratio R is 6, i.e., f₁=6f₂. In this example, the number of paths along the X₁ axis direction is 12, and the number of paths along the Y₁ axis direction is 2. For example, let it be assumed in shown in FIG. 4A that the length Wₓ of the beam spot S along its major axis is 150 μm and the length W_{y} along its minor axis is 30 μm; in that case, the ellipticity is 5, but from the standpoint of reducing the differences in processing line width that are associated with the scanning direction of the laser beam, the ratio R may be set to 6 as in this example.

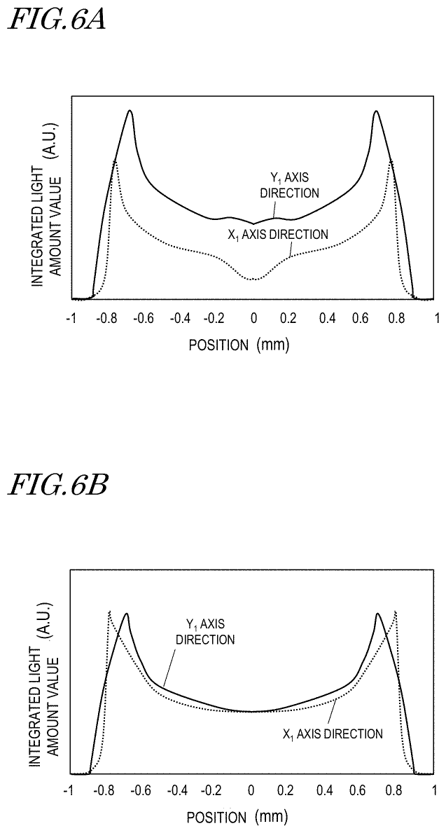

FIG. 6A is a graph illustrating example curves according to Comparative Example, obtained by plotting integrated light amount values along the X₁ axis direction and along the Y₁ axis direction. The horizontal axis represents coordinate position (mm) in the X₁Y₁ plane, and the vertical axis represents the integrated light amount value (A.U.) of the laser light radiated. The integrated light amount values are calculated by performing a 2-D convolution computation with a mathematical function defining the wobbling locus of the beam spot S and a mathematical function that is defined based on the energy distribution of a cross section of the beam spot.

In this Comparative Example, the wobbling locus of beam spot S is defined by the formulae X₁=sin(t), Y₁=cos(t).

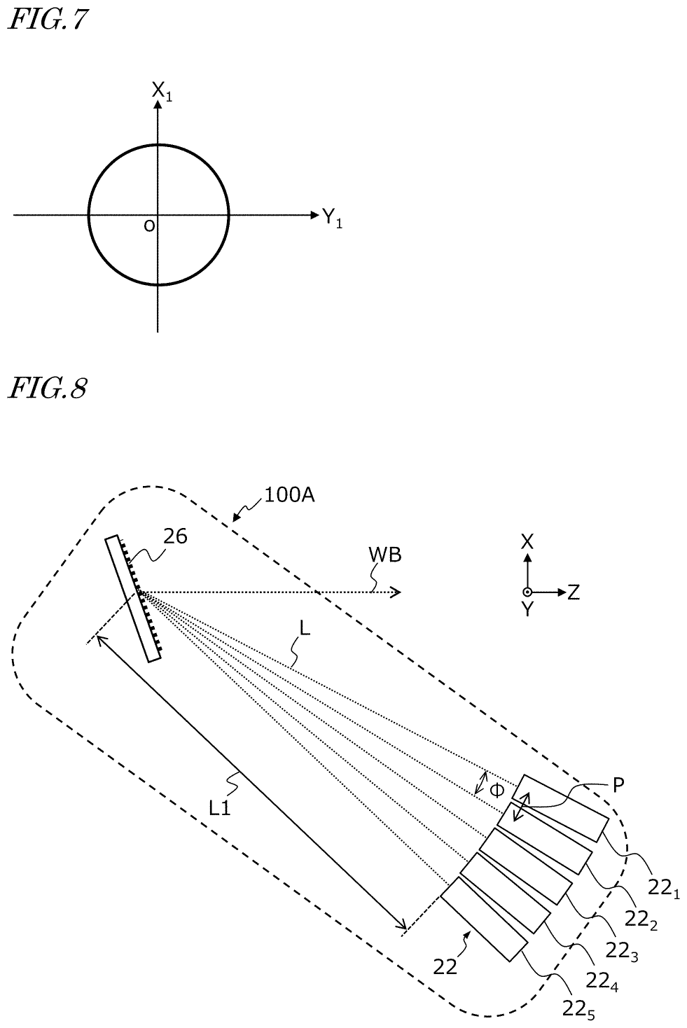

In other words, the ratio R is 1, and the locus has a circular shape as shown in FIG. 7. In this case, the curve obtained by plotting integrated light amount values along the X₁ axis direction differs from the curve obtained by plotting integrated light amount values along the Y₁ axis direction. More specifically, at each coordinate position, the integrated light amount value along the major axis direction is smaller than the integrated light amount value along the minor axis direction. From this Comparative Example it can be seen that a sufficient amount of irradiation is not obtained along the X₁ axis direction.

FIG. 6B is a graph illustrating example curves obtained by plotting integrated light amount values along the X₁ axis direction and the Y₁ axis direction, where the beam spot S is wobbled by the wobble pattern (ratio R=6) in the example of FIG. 5C. Because of setting the ratio R to 6, the curve obtained by plotting integrated light amount values along the major axis direction essentially matches the curve obtained by plotting integrated light amount values along the minor axis direction. A curve obtained by plotting integrated light amount values along an oblique direction intersecting the Y₁ axis direction at e.g. 30° or 45° would also essentially match the curves obtained by plotting integrated light amount values along the major axis direction and along the minor axis direction. According to this example, insufficiencies in the amount of laser light irradiation along the major axis direction can be remedied by making the first wobble frequency f₁ along the major axis direction six times as high as the second wobble frequency f₂ along the minor axis direction. As a result, without depending on the scanning direction of the laser beam, substantially uniform optical energy can be given to the target object W. The higher the ratio R is, the closer the beam spot formed on the target object will be to a pseudo circular spot.

In the laser processing apparatus according to the present embodiment, an elliptical beam spot is wobbled under a wobble mode in which a wobble frequency along the major axis direction of the beam spot is higher than a wobble frequency along its minor axis direction, whereby a pseudo circular spot can be formed on the target object. As a result, differences in processing line width that are associated with the scanning direction of the laser beam (see, for example, FIGS. 4A, 4B and 4C) can be reduced in processing a target object. Moreover, because this requires no additional lens such as cylindrical lens for beam shaping, the burden of lens alignment, etc., is eliminated, and the product costs can be reduced. As used herein, a circular spot is meant as a perfect circle; however, the beam spot S that is formed on the target object through wobbling is not to be limited to a perfect circle. That is, it suffices that the difference in length between the major axis and the minor axis of the wobbled beam spot is smaller than the difference in length between the major axis and the minor axis of the unwobbled beam spot.

Furthermore, by utilizing a laser processing apparatus according to the present embodiment, a DDL apparatus including at least one semiconductor laser diode is provided. Since the DDL apparatus does not require an optical fiber coupler or optical fibers, product costs can be kept smaller than in the case of a fiber laser apparatus.

Hereinafter, with reference to FIG. 8, another example configuration for the light source device included in the laser processing apparatus will be described.

The light source device 100A may include a plurality of LDs of different peak wavelengths. The light source device 100A is able to coaxially combine a plurality of laser beams emitted from the plurality of LDs to generate and emit a wavelength-combined beam.

First, an example of a basic configuration of a light source device which performs “wavelength beam combining” is described. FIG. 8 is a diagram showing an example configuration for the light source device 100A, which emits a combined laser beam that is obtained through wavelength beam combining. In the example of FIG. 8, the Y axis is the viewing direction of FIG. 8, which schematically shows a view parallel to the XZ plane of the light source device 100A. The propagation direction of the wavelength-combined beam WB is parallel to the Z axis direction.

In the example shown in FIG. 8, the light source device 100A includes a plurality of laser modules 22 configured to emit a plurality of laser beams L of different peak wavelengths λ, and a beam combiner 26 configured to combine the plurality of laser beams L to generate a wavelength-combined beam WB. FIG. 8 illustrates five laser modules 22₁ to 22₅.

Thus, the light source device 100A coaxially combines the plurality of laser beams L of different peak wavelengths λ to generate and emit the wavelength-combined beam WB. In the present disclosure, the term “wavelength-combined beam” refers to a laser beam in which a plurality of laser beams L of different peak wavelengths λ are coaxially combined through wavelength beam combining. Through wavelength beam combining, n laser beams of different peak wavelengths λ are coaxially combined, so that not only the optical output power but also the fluence (unit: W/cm²) can be increased to about n times the fluence of each individual laser beam L.

In the example shown in FIG. 8, the beam combiner 26 is a reflection-type diffraction grating. Components other than a diffraction grating may be employed for the beam combiner 26, and the beam combiner 26 may also be another wavelength-dispersion optical element, for example, a prism. The laser beams L are incident on the reflection-type diffraction grating at different angles, from which minus-first order reflection-diffracted light beams of the laser beams L are emitted in the same direction. In FIG. 8, for simplicity, the center axis of each laser beam L and the center axis of the wavelength-combined beam WB are illustrated to indicate each laser beam L and the wavelength-combined beam WB.

As used herein, the distance from each laser module 22 to the reflection-type diffraction grating (beam combiner 26) is indicated by L1, and the angle between two adjacent laser modules 22, i.e., the angle between two adjacent laser beams L, is indicated by Φ (radian: rad). In the example shown in FIG. 8, the distance L1 and the angle Φ are uniform among the laser modules 22₁ to 22₅. Assuming that the arrangement pitch (intervals between emitters) of the laser modules 22 is P, an approximate expression Φ×L1=P holds true.

A laser processing method according to an embodiment of the present disclosure includes: converging a laser beam emitted from a light source device and forming on a target object a laser beam spot having an elliptical shape with a major axis and a minor axis; and scanning the target object with the laser beam while wobbling the laser beam spot under a wobble mode in which a first wobble frequency along the major axis direction of the laser beam spot is higher than a second wobble frequency along the minor axis direction of the laser beam spot. The laser processing method can be performed by using the aforementioned laser processing apparatus 1000, for example. The laser processing method can be used for performing processing such as cutting, punching, or marking for various kinds of materials, or welding a metal material.

A method for processing a workpiece according to an embodiment of the present disclosure includes a step of welding the workpiece by using the aforementioned laser processing method. By using a laser beam that forms an elliptical beam spot on the bonding site to scan the workpiece along a welding line in welding the weld zone, where the beam spot is wobbled under a wobble mode according to the present embodiment, a workpiece which requires precise welding work can be produced. In another embodiment, the method for processing a workpiece includes, by using the aforementioned laser processing method, forming an elliptical beam spot on a surface of the workpiece and performing a punching process on the surface of the workpiece. According to this processing method, a workpiece which requires a precise punching process can be produced.

With the laser processing method according to the present embodiment, and the method for processing a workpiece that involves the laser processing method, an elliptical beam spot is wobbled by setting the wobble frequency along the major axis direction so as to be higher than the wobble frequency along the minor axis direction. Thus, differences in processing line width that are associated with the scanning direction of the laser beam can be reduced in processing the target object.

The laser processing apparatus and laser processing method according to the present disclosure may be used for the cutting or punching of various materials, localized heat treatments, surface treatments, metal welding, 3D printing, and the like.

1. A laser processing apparatus comprising:
a light source device configured to emit a laser beam;
a laser head having a lens and being configured to converge through the lens a laser beam emitted from the light source device and to irradiate a target object with the converged laser beam;
a wobbling mechanism configured to wobble a laser beam spot formed on the target object by the converged laser beam, the laser beam spot having an elliptical shape with a major axis and a minor axis; and
a control device configured to control the wobbling mechanism under a wobble mode in which a first wobble frequency along the major axis direction of the laser beam spot is higher than a second wobble frequency along the minor axis direction of the laser beam spot.

2. The laser processing apparatus of claim 1, wherein a ratio of the first wobble frequency to the second wobble frequency is not less than 2.0 and not more than 100.

3. The laser processing apparatus of claim 1, wherein the ratio of the first wobble frequency to the second wobble frequency is adjusted in accordance with a scanning direction of the laser beam.

4. The laser processing apparatus of claims 1, wherein the wobbling mechanism is a galvano scanner.

5. The laser processing apparatus of claim 1, wherein the lens is an fθ lens.

6. The laser processing apparatus of claim 1, wherein the light source device comprises a semiconductor laser diode.

7. The laser processing apparatus of claim 1, wherein,
the light source device comprises a plurality of semiconductor laser diodes of different peak wavelengths; and
the light source device is configured to coaxially combine a plurality of laser beams emitted from the plurality of semiconductor laser diodes to generate and emit a wavelength-combined beam.

8. A laser processing method comprising:
converging a laser beam emitted from a light source device so as to form a converged laser beam and forming on a target object a laser beam spot from the converged laser beam, wherein the laser beam spot an elliptical shape with a major axis and a minor axis; and
scanning the target object with the converged laser beam while wobbling the laser beam spot under a wobble mode in which a first wobble frequency along the major axis direction of the laser beam spot is higher than a second wobble frequency along the minor axis direction of the laser beam spot.

9. A method for processing a workpiece comprising a step of welding the workpiece by using the laser processing method of claim 8.

10. A method for processing a workpiece comprising a step of performing a punching process on a surface of the workpiece by using the laser processing method of claim 8.
